(19) United States
(12) Patent Application Publication
(10) Pub. No.: US 2018/0284030 A1
(43) Pub. Date: Oct. 4, 2018

(54) Automated FTIR Spectrometer

(71) Applicant: De Beers UK Ltd, London, Greater London (GB)

(72) Inventors: Luke Michael Smith, Buckinghamshire (GB); Brad Cann, Berkshire (GB); Peter Stanley Rose, Buckinghamshire (GB); David Fisher, Berkshire (GB); Juan Abelaira, Berkshire (GB); Philip Maurice Martineau, Berkshire (GB)

(21) Appl. No.: 15/764,636

(22) PCT Filed: Sep. 29, 2016
(86) PCT No.: PCT/GB2016/053034

§ 371 Date: Mar. 29, 2018

(30) Foreign Application Priority Data
Oct. 2, 2015 (GB) 1517438.6

(51) Int. Cl. G01N 21/87; G01N 21/3563

(52) U.S. Cl. CPC G01N 21/87; G01N 2021/3595; G01N 21/3563

(57) ABSTRACT

A system for placing a sample at a predefined measurement location for measuring an optical property of that sample. The apparatus includes a measurement platform for supporting the sample at the measurement location, the measurement platform having an orifice therein beneath the measurement location, and a nozzle configured to retain the sample therein when a vacuum is applied to the nozzle. The sample is contacted by the nozzle, and a vacuum is applied to the nozzle so that the sample is retained therein by air pressure. The nozzle with the sample retained therein is then transported to the measurement location. The vacuum at the nozzle is disabled to release the sample from the nozzle, and a vacuum is applied to the orifice in the measurement platform so as to retain the sample on the measurement platform. The nozzle is then retracted away from the measurement platform.

### TECHNICAL FIELD

The present invention relates to a method and an apparatus for precise placement of cut gemstones for measurement. In particular, although not exclusively, the invention relates to a method and an apparatus for placing cut gemstones at a measurement position in a spectrometer or other similar instrument.

### BACKGROUND

Natural diamonds are stones from nature, consisting exclusively of diamond formed by geological processes over long periods of time. Synthetic diamonds are man-made stones manufactured by industrial processes, such as HPHT (high pressure high temperature) and CVD (chemical vapour deposition). Synthetic diamonds may be relatively easy to distinguish from natural diamonds when in an unpolished state, however, once polished and cut into a gemstone, identification that a stone is synthetic may be more difficult.

A number of screening instruments, such as the DiamondSure™ and DiamondView™, may be used to test whether a stone is natural or synthetic. Typically, such screening involves measuring the way in which light is absorbed by or emitted from a diamond. For example an instrument incorporating an FTIR absorption spectrometer may be used to obtain an infra-red absorption spectrum of a stone. Analysis of such spectra usually provides a good indication of whether a stone is natural or synthetic.

The ideal spectral acquisition arrangement is for the sample to be placed table-down at a precise measurement location on a flat measurement platform in a measurement chamber. This allows a background/reference measurement to be taken with no changes to the physical configuration of the measurement platform. Such changes might include the manual placement of a blanking plate or similar to provide an adequate background/reference signal.

In addition to screening larger, individual stones, it is also necessary to screen large numbers of smaller diamonds, including stones sometimes known as melee. Melee is a term of the trade that does not have a well-defined size range, but can be considered in practice to refer to stones smaller than about 0.2 carats (20 points), and usually (but not necessarily) larger than about 0.01 or 0.02 carats. Due to their small size, melee stones are typically sold in parcels or lots. Since one parcel may contain hundreds of stones, it is possible for synthetic diamonds to be mixed in with natural stones.

Screening of melee diamonds can potentially be extremely time consuming, since each stone must be tested individually and therefore placed in the correct orientation individually. When analysing large numbers of samples (particularly small samples) in a spectrometer it is desirable to automate the placement of those samples within the measurement chamber. This in turn allows automation of the measurement process, the decision making and appropriate dispensing to be completed with minimal manual intervention.

A convenient means by which stones may be automatically placed on the spectrometer measurement platform is with a simple pick and place vacuum nozzle arrangement. A device such as that described in WO 2012/146913 can be used initially to orientate gemstones table-down. Once in this orientation, individual stones can be lifted by a vacuum wand and transported to the spectrometer.

Once selected and picked-up by the vacuum wand, each stone is carried to and placed on the measurement platform, the vacuum disabled and the nozzle retracted to allow measurement of the optical characteristics of the sample. However, when making high resolution spectroscopic measurements it is desirable, particularly in the case of FTIR measurements, to reduce the water vapour in the measurement chamber to as low a level as possible. When measuring small insulating samples (such as diamond), this low humidity environment can give rise to electrostatic charging of the samples. This can cause the samples to be retained in the placement nozzle rather than being left on the measurement platform. Although it is in theory possible to apply a gentle puff of air to release the stone this would cause the stone to be placed with poor accuracy leading to an impaired measurement. Similarly, deionising arrangements will also tend to disturb the sample positioning accuracy.

In addition, particularly where the sample is diamond, in an automated handling system it is desirable that all samples are free from grease and other contaminants in order to prevent adhesion of the samples to the feeding system, or each other. In the case of diamond samples acid cleaning is optimal, however, this leaves the surface oxygen terminated and insulating, which will allow electrostatic charge to accumulate. An alternative would be hydrogen termination of the samples resulting in a conductive surface, however this would require substantial additional apparatus.

It is therefore desirable to achieve a reduction of water vapour in the measurement chamber, but without additional handling complications. One approach might be that all stone handling would take place in an environment of high humidity whilst the measurements themselves take place in an environment of low humidity. Such a situation is not easy to achieve since a physical path between the two environments must be opened when the sample is being placed inside the measurement chamber and this will lead to an impairment of the low humidity environment in the measurement chamber. Although an air-lock arrangement would be a solution to this problem, this would introduce significant additional complexity and cost.

In conventional robotic designs it is highly desirable never to let go′ of an item once it has been placed. This is difficult to achieve in spectroscopic measurements where a sample is placed by a vacuum nozzle, since the placement nozzle will tend to obscure part of, or even all, of the sample from the spectrometer sampling beam.

It is also desirable to avoid any obstruction of the spectrometer sampling beam such as might be caused by separate mechanisms designed to hold a placed stone. Such mechanisms would be particularly detrimental to spectra from small samples and would also cause difficulties with spectrometer background/reference measurements.

If the loss in signal of holding the sample is place were to be accepted, then the nozzle geometry could be altered to allow the spectrometer beam to enter and exit the stone. This could allow the measurement to take place whilst the stone remains in contact with the nozzle. It has been established that such an arrangement results in an inferior signal to noise ratio to the situation when the nozzle is retracted away from the sample. This can sometimes be accommodated if the sample is large compared to the nozzle, but is generally not practical for smaller sized samples such as melee.

### SUMMARY

In accordance with one aspect of the present invention there is provided an apparatus for placing a sample at a predefined measurement location for measuring a property, optionally an optical property, of that sample. The apparatus comprises a measurement platform for supporting the sample at the measurement location, a nozzle configured to retain the sample therein when a vacuum is applied to the nozzle, a nozzle vacuum system for selectively applying a vacuum to the nozzle, and a transport mechanism for moving the nozzle with the sample retained therein to the measurement location. The measurement platform has an orifice therein beneath the measurement location, and a measurement vacuum system is provided for selectively applying a vacuum to the orifice so as to retain the sample at the measurement location. A control system is configured to control the nozzle vacuum system, measurement vacuum system and transport mechanism. When the sample has been transported to the measurement location by the nozzle, the measurement vacuum system applies a vacuum to the orifice and the nozzle vacuum system cuts off the vacuum from the nozzle. The transport mechanism then retracts the nozzle away from the measurement platform leaving the sample retained in place by the measurement vacuum system.

Thus the sample is held securely in place at all times, either within the nozzle or against the measurement platform. The nozzle can bring the sample to the measurement location with a great deal of accuracy. Then, before the nozzle is retracted, the sample is held in place against the platform by the vacuum applied through the orifice.

Once measurement has taken place, the nozzle may be re-advanced to contact the sample. The vacuum can then be re-applied to the nozzle and cut off from the orifice, enabling the nozzle to transport the sample away from the measurement location.

When the sample has been placed at the measurement location, the vacuum to the nozzle can be removed before, after, or simultaneously with the vacuum being applied to the orifice. In one embodiment the nozzle and measurement vacuum system together comprise a pump for supplying a vacuum, and a diverter valve for applying the vacuum to either the nozzle or the orifice.

The apparatus may further comprise a measurement instrument including a measurement chamber within which is located the measurement platform, the measurement chamber being configured so that it can be purged of water vapour.

The apparatus may include a purging system for flooding the measurement chamber with dry gas to a pressure higher than atmospheric pressure. An entry hole may be provided through which the nozzle with the sample retained therein can pass to reach the measurement location.

The measurement instrument or transport mechanism may be mounted on a movable stage to enable precise adjustment of the location of the measurement platform relative to the transport mechanism.

The measurement instrument may be a spectrometer, optionally an absorption spectrometer, and optionally an FTIR spectrometer.

The transport mechanism may comprise a pivotable arm from which is suspended a vacuum wand, the nozzle being provided in a distal end of the vacuum wand.

The sample may be a gemstone, optionally a cut gemstone. The apparatus may further comprise an orientation unit for orientating samples into a suitable orientation for insertion into the nozzle prior to transportation to the measurement location. Where the samples are cut gemstones, this orientation may be table-down.

The control system may be configured to cause the transport mechanism to transport the sample to one of a plurality of dispensation points following the measurement, the dispensation point chosen in dependence on the outcome of the measurement.

The apparatus may further comprise a tool for assisting with calibration of relative alignment of the nozzle and measurement platform. The tool may comprise a cap configured to be located over the nozzle and held in place by the nozzle vacuum system, and a spigot extending from a distal end thereof and configured for insertion into the orifice when the nozzle and orifice are aligned. This enables very accurate calibration of the alignment of the nozzle and the orifice.

In accordance with another aspect of the present invention there is provided a measurement instrument for measuring an optical property of a sample at a measurement location. The instrument comprises a sealed measurement chamber configured so it can be purged of water vapour. A measurement platform is located within the measurement chamber for supporting the sample at the measurement location. The measurement platform has an orifice therein beneath the measurement location. The apparatus further includes a measurement vacuum system for selectively applying a vacuum to the orifice in the measurement platform so as to retain the sample at the measurement location following delivery to the measurement location by a vacuum nozzle. An optical system is configured to transmit light to the measurement location and detect light emitted from or passing through the measurement location so as to obtain a measurement of the optical property of the sample.

The instrument may further comprise an entrance hole in the measurement chamber to provide access to the measurement platform for the sample retained within the vacuum nozzle.

In accordance with another aspect of the present invention there is provided a method of placing a sample at a measurement location for measuring an optical property of the sample. The method comprises contacting the sample with a nozzle, applying a vacuum to the nozzle so that the sample is retained therein by air pressure, and transporting the nozzle with the sample retained therein to the measurement location. The measurement location is on a measurement platform having an orifice therein. Once at the measurement location, the vacuum at the nozzle is disabled to release the sample from the nozzle and a vacuum is applied to the orifice in the measurement platform so as to retain the sample on the measurement platform. The nozzle is then retracted away from the measurement platform, leaving the sample retained securely and accurately at the measurement location ready for a measurement to be taken.

The steps of disabling the vacuum at the nozzle and applying the vacuum to the orifice may be carried out substantially simultaneously by diverting a vacuum supply from the nozzle to the orifice.

Following the measurement, the nozzle may be advanced to contact the sample on the measurement platform. The vacuum at the orifice may then be disabled to release the sample from the measurement platform, and a vacuum applied to the nozzle so as to retain the sample therein. The sample in the nozzle may then be transported to a dispensation point, and the vacuum to the nozzle disabled to dispense the sample. Part of the dispensation process may involve applying positive air pressure to the sample to ensure it is pushed off the nozzle.

In accordance with a further aspect of the present invention there is provided a method of calibrating alignment of a nozzle with a measurement location, where the nozzle is designed for transporting a sample to that measurement location. The method comprises placing an alignment tool having a cap and a spigot extending from a distal end thereof over the nozzle and applying a vacuum to the nozzle so that the cap is retained thereon by air pressure. The nozzle with the cap retained thereon is transported (lowered) towards the measurement location, which is on a measurement platform having an orifice therein. It is determined that the nozzle and measurement platform are correctly aligned if the spigot enters the orifice. If not, the position of the nozzle may be adjusted until the spigot can enter the orifice.

### BRIEF DESCRIPTION OF THE DRAWINGS

Some preferred embodiments of the invention will now be described by way of example only and with reference to the accompanying drawings, in which:

FIG. 1 is a perspective view of the interior of an assembly for automatic placement of samples such as cut gemstones in a spectrometer, and subsequent dispensation of such samples depending on the results of spectral analysis;

FIG. 2 is a side view of the assembly of FIG. 1;

FIG. 3 is a top view of the assembly of FIG. 1;

FIGS. 4 and 5 are close-up views of moveable mirrors forming part of a spectrometer forming part of the assembly of FIG. 1;

FIG. 6 is a cross section through part of the spectrometer shown in of FIGS. 1 and 4;

FIG. 7 is a cutaway end view of the spectrometer shown in FIGS. 1 and 4;

FIG. 8 is a detailed schematic view of a measurement platform in the spectrometer of FIG. 4;

FIGS. 9 and 10 are schematic views of vacuum systems for use in the assembly of FIG. 1;

FIG. 11 is a flow chart showing the sequence of operation of the assembly of FIG. 1; and

FIG. 12 is a diagram illustrating a tool for alignment of a measurement platform in the spectrometer of FIG. 4.

### DETAILED DESCRIPTION

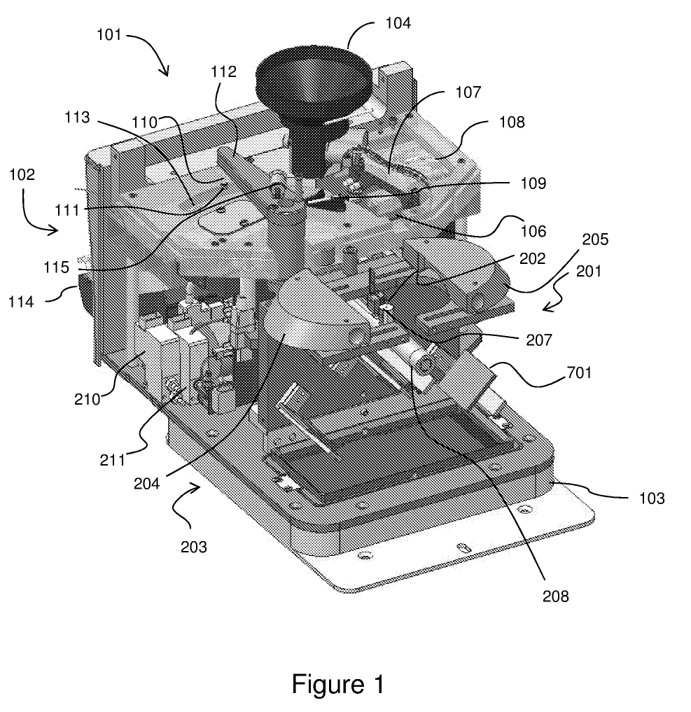

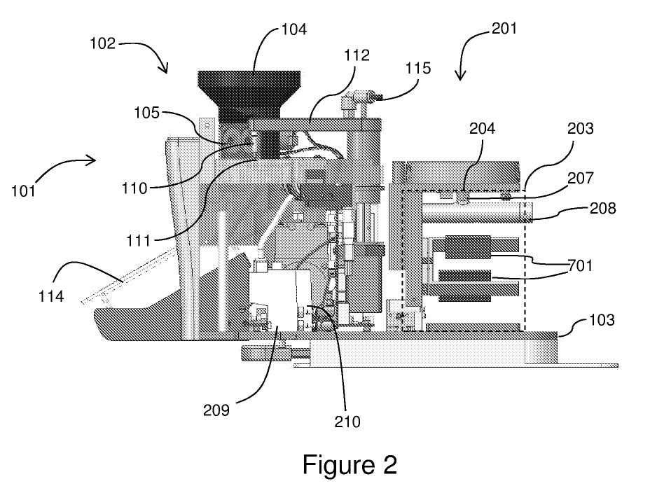

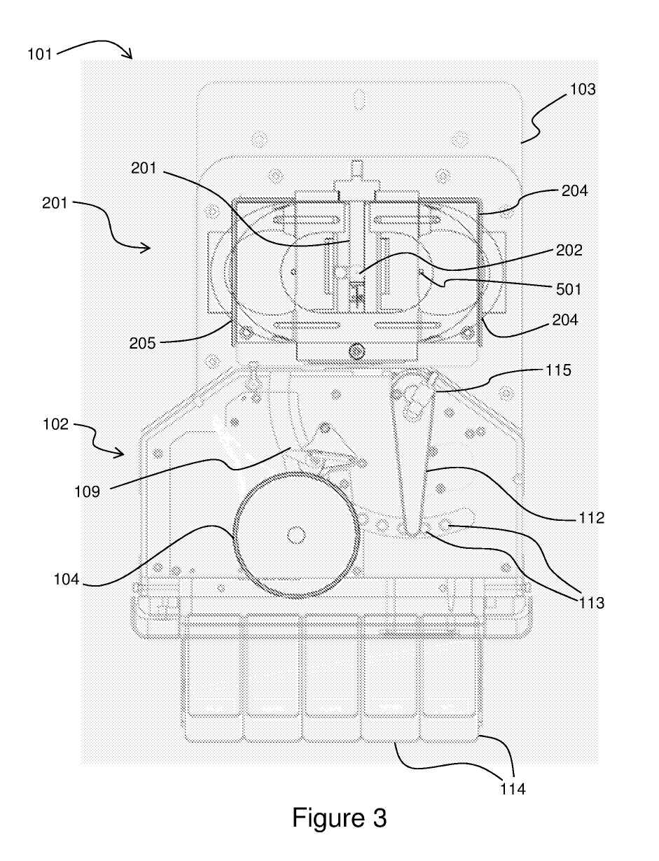

FIG. 1 is a perspective view of the interior of an assembly 101 for automatic placement of samples such as cut gemstones in a spectrometer, and subsequent dispensation of such samples depending on the results of spectral analysis. FIG. 2 is a side view and FIG. 3 a top view of the same assembly 101. The assembly may be designed for use with stones of any size, but is particularly useful for measurement of melee (stones up to about 0.2 carat) or other small stones (up to about 0.3-0.4 carat).

The assembly 101 comprises a gemstone orientation unit 102 arranged next to a spectrometer 201 on a common mounting plate 103.

The gemstone orientation unit is similar to that described in WO 2012/146913 and is designed to orientate gemstones table down. Melee or other small stones are poured into a hopper 104 and pass through a pair of rollers 105. The speed of the rollers 105 is configured to separate out the stones so they pass through substantially one at a time. The stones are then directed onto a rotating disc 106 (shown more clearly in WO 2012/146913). The disc 106 rotates clockwise and provides a circular travelling path, passing the stones through an agitator (shown more clearly in WO 2012/146913). The agitator comprises a pair of opposed parallel vertical walls which form a semi-circular channel 107. The walls are connected to an oscillator 108 which oscillates the walls with sufficient magnitude and frequency that they collide with the stones on the travelling path, with sufficient force to knock them onto their table facet if they are not already that way aligned, but not enough force to knock them off their table facet.

A camera coupled to a processing unit (not shown) identifies when a stone on the rotating disc 106 reaches a handling area 109, at which point the rotation of the disc 106 and oscillation of the agitator is temporarily halted. The processing unit confirms that the stone is indeed orientated table-down and, if so, a vacuum wand 110 suspended from a pivotable arm 112 and culminating in a nozzle 111 at its distal end is moved to the handling area, and vacuum applied to pick up the stone. The pivotable arm 112 then swings to transport the stone to the spectrometer 201, where it is placed in a measurement chamber as described in more detail below. Following measurement by the spectrometer, the stone is again picked up by the vacuum nozzle 111 of the wand 110 and transported to one of a number of dispensation points 113, chosen in dependence on the measurement made by the spectrometer 201. Below each dispensation point is a channel which leads to one of a number of bins 114. Stones may be dispensed to different bins on the basis of categories which may include, for example: “not diamond material”, “natural diamond”, “diamond, refer for further tests”, although it will be appreciated that sorting can be determined by any measured properties.

The spectrometer 201 comprises a measurement platform 202 within a measurement chamber 203. The walls of the measurement chamber are generally not shown in FIG. 1, but the dotted line 203 in FIG. 2 identifies the extent of the chamber. Two ellipsoidal mirrors 204, 205 are provided at the top of the chamber, movable between a closed position in which the mirrors are located just above and around the measurement platform 202, and an open position (as shown in FIG. 1) which provides access to the interior of the chamber. When the mirrors are in the closed position a small hole 501 (shown in FIGS. 3, 4 and 5) provides enough space between them to lower a sample from above the mirrors down to the measurement platform, to be placed at a measurement location on the platform.

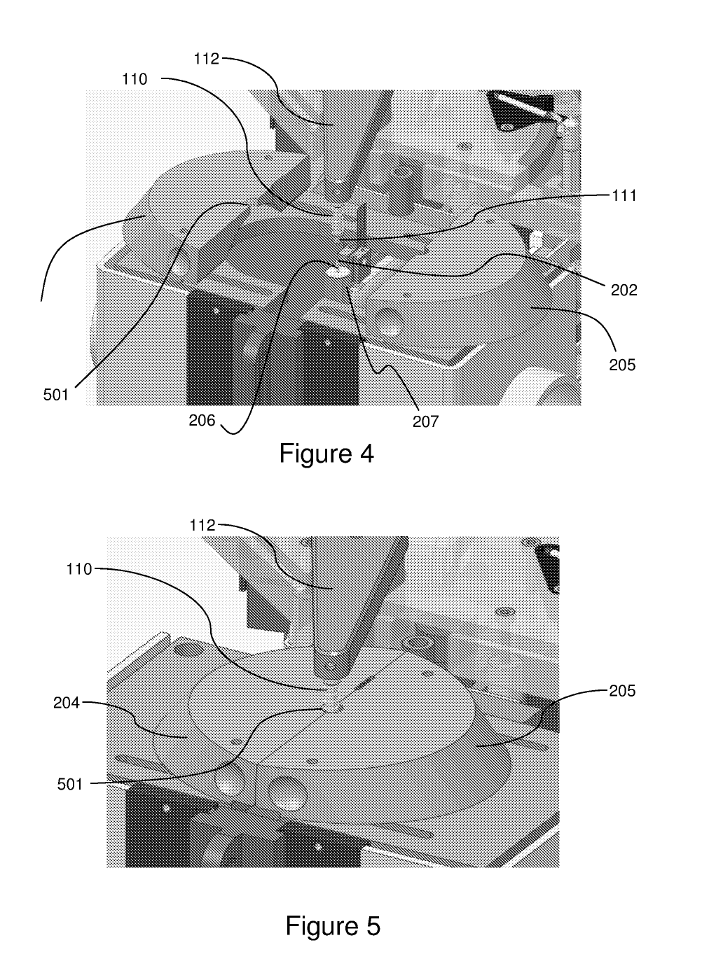

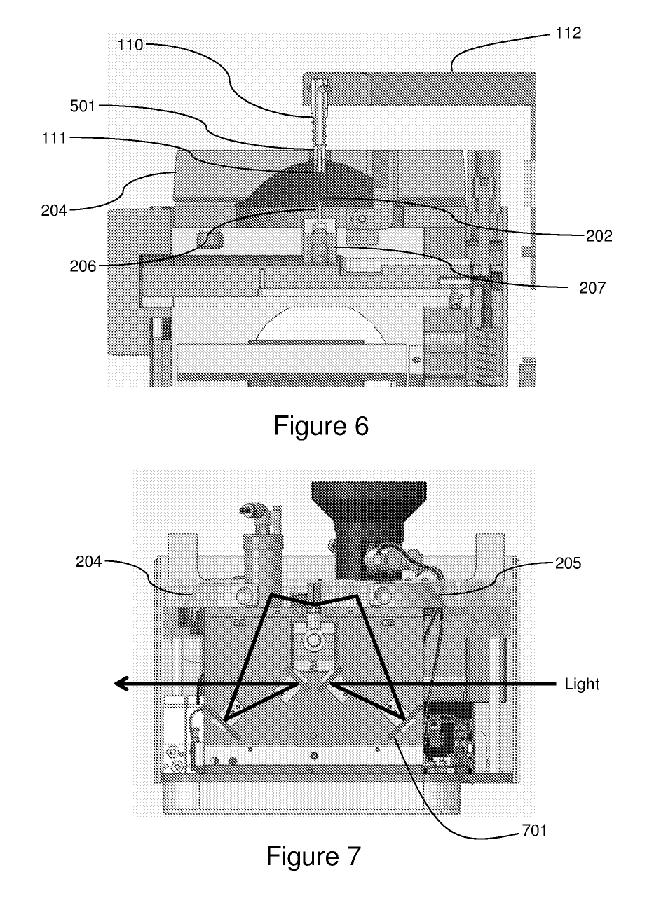

FIGS. 4 and 5 are close-up views of the moveable mirrors 204, 205. In FIG. 4 the mirrors are in the open position, and in FIG. 5 the mirrors are in the closed position. FIGS. 4 and 5 illustrate the small hole 501 that is formed when the mirrors are in the close position. The hole 501 needs to be large enough to accommodate entry of the nozzle 111 and the wand 110, but as small as possible to limit ingress or egress of gas from the chamber. A suitable diameter is about 10 mm, but this will depend on the size of the nozzle 111. FIG. 6 is a cross section through a top portion of the spectrometer 201, showing the fit of the wand 110 and nozzle 111 through the hole 501.

Within the measurement chamber is provided a set of reflective elements 701 for directing a beam of light from a source (not shown) onto one of the ellipsoidal mirrors and thus to the measurement location (and into a sample when placed on the measurement platform 102), as shown in FIG. 7. Light passing through the measurement location is reflected from further reflective elements out of the measurement chamber towards a detector. It will be understood that this arrangement of reflectors is illustrative only and any suitable arrangement for providing light to the sample and detecting transmitted light may be used. In FIG. 7 the ellipsoidal mirrors 204, 205 are shown in the retracted positions so as to show the position of the measurement platform more clearly, but it will be appreciated that, in practice, the ellipsoidal mirrors 204, 205 will be in the closed position (as shown in FIG. 5) when the measurement is taken.

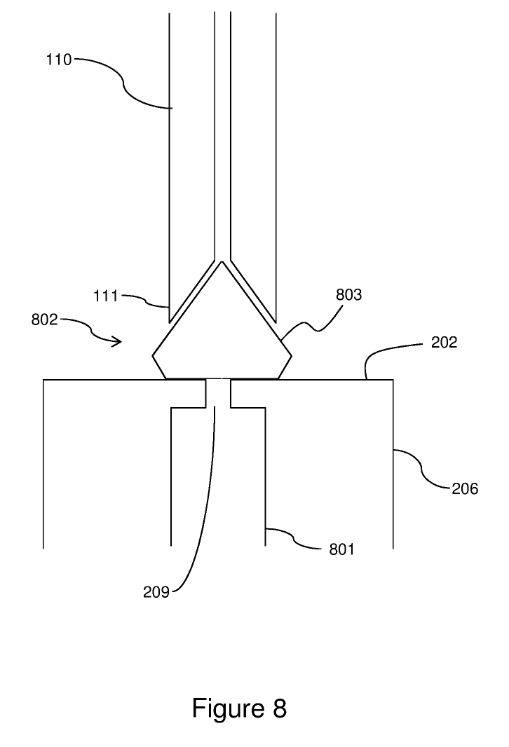

As can be seen from FIGS. 1, 4 and 5, the measurement platform 202 is located at the top of a very narrow cylinder 206, itself mounted at the top of short cylinder 207 supported on and extending vertically from a vacuum supply tube 208. The measurement platform 202 is shown in more detail in FIG. 8. The cylinder 206 has a bore 801 passing therethrough and culminating in an orifice 209 in the measurement platform 202 immediately beneath the measurement location 802. The other end of the bore opens into the vacuum supply tube 208, which is connected to a vacuum pump (not shown). A vacuum can also be supplied to the vacuum wand 110 and thus to the nozzle 111 via a vacuum supply connection 115 mounted on the pivotable arm 112. Vacuum to the vacuum nozzle 111 and orifice 209 in the measurement platform may be provided from the same pump and controlled using solenoid valves 210, 211. This arrangement enables a controlled vacuum to be applied to the orifice 209 in the spectrometer measurement platform 202. FIG. 8 also shows a stone 803 in place at the measurement location 802, held in place by a vacuum applied through the bore 801 and orifice 209 in the measurement platform 202.

The spectrometer 201 is mounted on an x-y adjustment stage 212 which enables its location to be controlled very accurately to ensure that stones transferred from the handling area can be reliably placed on the measurement platform 202 at the correct measurement location optimised for alignment with light in the spectrometer 201. If the whole instrument is made as a single unit the x-y stage may not be necessary, but its presence makes it possible to combine the spectrometer with any system capable of delivering samples repeatably using a vacuum nozzle. It will be appreciated that (depending on the size of spectrometer) it may be more appropriate to mount the gemstone orientation unit 102 on an x-y adjustment stage, so that the gemstone orientation unit 102 moves while the spectrometer 201 remains stationary. As long as it is possible for relative movement between the spectrometer 201 and gemstone orientation unit 102 it is possible to optimise placement of the stones for correct alignment. It may also be appropriate to mount the gemstone orientation unit directly onto a spectrometer casing (rather than the common mounting plate 103), optionally incorporating an x-y adjustment stage into the mounting.

In use, the measurement chamber 203 of the spectrometer 201 is purged to ensure removal of all water vapour. This may be done, for example, by purging with dry air or with dry nitrogen. A slight overpressure may be maintained to ensure that no water vapour can enter through the small hole 501 between the mirrors 204, 205. The spectrometer may also be calibrated at this stage by obtaining a spectrum with no stone at the measurement location. The vacuum wand 110 is then used to transport a gemstone from the orientation unit 102 to the spectrometer 201. Initially, the wand is lowered towards a gemstone located at the handling area 109 of the orientation unit 102 until the nozzle 111 contacts the stone, and a vacuum is applied to the nozzle 111. Air pressure causes the stone to be retained in the nozzle 111, and the wand 110 is raised and the pivotable arm 112 swung until that the wand is located above the measurement location (i.e. above the orifice 209 in the measurement platform 202 of the spectrometer). The nozzle 111 is then lowered until the stone contacts the measurement platform 202. At this point the stone should be retained within the nozzle 111, with its table facet covering the orifice 209 in the measurement platform 202.

While the nozzle 111 remains in place (thereby ensuring precise positioning of the stone on the measurement platform 202 at the measurement location), a vacuum is applied through the bore of the cylinder 207 to the orifice 209 in the measurement platform 202, and the vacuum applied to the nozzle 111 is disabled. The stone is now held in place on the measurement platform by air pressure because of the vacuum underneath. This allows the wand 110 and nozzle 111 to be retracted whist the stone is retained at the measurement location by the vacuum applied through the measurement platform. This has the desirable benefit of maintaining good sample placement accuracy.

The spectrometer 201 is then operated to obtain spectroscopic measurements of the stone. In the example shown, the spectrometer is a FTIR spectrometer: light from a source (not shown) enters the spectrometer, passes through the sample under investigation, and is directed towards a detector (not shown). Information from the detected light is passed to a processor so as to generate an infra-red absorption spectrum.

Once the spectroscopic measurements have been taken, the nozzle 111 is again lowered until it contacts the stone and the stone is contained within a recess of the nozzle. A vacuum is re-applied to the nozzle 111, and removed from the orifice 209 in the measurement platform 202. The wand 110, with the stone held in place in the nozzle by air pressure, is then retracted away from the measurement platform.

A decision as to the provenance of the gemstone can be made by the processor on the basis of the absorption spectrum. Examples include a determination that the stone is not diamond, or that the stone is natural diamond, or that the stone includes diamond material but further tests are necessary to determine whether or not it is natural. Further examples of suitable analysis and decision making can be found in WO 2013/186261. The pivotable arm 112 then swings to transport the stone to one of the dispensation points 113, chosen on the basis of the decision made by the processor, and the vacuum to the nozzle is disabled so that the stone is released and delivered to an appropriate bin 114. Optionally it is possible to apply a small positive air pressure to cause the stone to be gently ejected from the vacuum wand. This is particularly useful if the stone has acquired an electrostatic charge or has a greasy contamination or similar which would otherwise cause it to be retained in the vacuum wand owing to the weight of the stone not being sufficient to overcome these effects and cause the stone to drop. In such cases it is possible to use the exhaust from the vacuum pump to apply this pressure thereby avoiding the need for an additional pump. This beneficial arrangement may be realised by means of a single additional valve.

When making spectroscopic measurements it is desirable to ensure that the measurement platform 202 is as small as possible (commensurate with being able to support the sample) to ensure that any light collected from the measurement area has passed through the stone; if the platform is larger than the sample then some detected light will not have passed through the sample. This will have an adverse effect on acquired spectra.

Furthermore, in an automated system it is advantageous to be able to acquire reference or background spectra during a measurement cycle without manual intervention. To do this, and avoid additional robotics, the platform needs to be used as a reference mirror. As discussed previously, there is a requirement to apply a vacuum to the measurement platform. This implies that the platform, and so reference mirror, will need to include an orifice. The platform with the orifice is used as a reference mirror in collection of background spectra when no sample is on the platform. It is possible to subtract the same background spectrum from the spectra of all samples in a batch of samples but there is a risk that the shape of the actual background spectrum could drift over the timescale of many sample measurements. To reduce the associated risk of distortion of spectra it is possible to record background spectra after collection of each sample spectrum. This may be achieved in the time interval during which the removal of one sample and placement of the next.

In order to maximise the applied vacuum it would be desirable to have as large an orifice as possible, thereby minimising any airflow constriction. However, the larger the orifice, the more intense the artefacts that will be introduced into each spectrum as a result. It is therefore desirable to optimise the size of the orifice through which this vacuum is applied, whilst also minimising the adverse effects on the acquired spectra.

As discussed above, the control of the vacuum may be handled by solenoid valves 210, 211. These can enable vacuum to be switched between the orifice 209 in the measurement platform and the nozzle 111 using a simple ‘diverter’ or changeover valve. In this configuration vacuum is applied either to the nozzle or the platform but it is not possible (without an additional valve) to completely disable the vacuum. This allows the scheme to be implemented at very modest cost provided the leakage caused by the permanent use of vacuum is acceptable. Given that the orifice in the platform of the spectrometer is made as small as possible in order not to compromise the acquired spectra this leakage is acceptable.

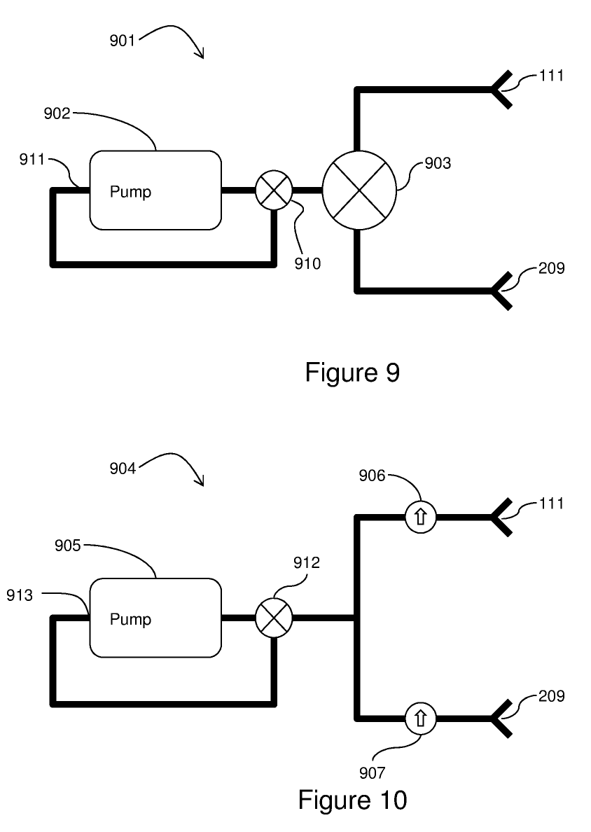

FIG. 9 is a schematic diagram of a vacuum system 901 which supplies vacuum to either a nozzle 111 at the end of a vacuum wand or orifice 209 in a measurement platform 202. The vacuum system 901 includes a pump 902 and diverter valve 903 which enables vacuum to be applied to one or other of the nozzle 111 or orifice 209, but not both. The diverter valve may be a solenoid valve such as the valves 210, 211 shown in FIGS. 1 and 2.

FIG. 10 is a schematic diagram of an alternative configuration for a vacuum system for supplying vacuum to a nozzle 111 at the end of a vacuum wand or orifice 209 in a measurement platform 202. The vacuum system 904 includes a pump 905 and two valves 906, 907 which enable vacuum to be selectively applied to the nozzle 111 or orifice 209 independently. The valves 906, 907 may again be the solenoid valves 210,211 shown in FIGS. 1 and 2. An advantage of the configuration of FIG. 10 is that it is possible to apply the vacuum to the orifice 209 in the measurement platform 202 before the vacuum at the nozzle 111 is disabled, ensuring that the stone is held firmly in position as it is transferred from the nozzle to the measurement platform. Similarly, when the stone is subsequently picked up by the nozzle from the measurement platform, the arrangement of FIG. 10 makes it possible for the vacuum at the nozzle 111 to be applied before the vacuum at the table 202 is disabled. Furthermore, the arrangement of FIG. 10 makes it possible to allow the vacuum in the measurement chamber to be disabled when not required, thereby reducing further the additional ‘leakage’ of dry air.

Both FIGS. 9 and 10 illustrate an additional valve 910, 912 which can be used to connect the exhaust 911, 913 of the pump 902, 905 to the nozzle 111 when required, in order to push the stone out of the nozzle when dispensing into a chosen bin as described above.

FIGS. 9 and 10 can be understood as illustrating a measurement vacuum system for applying a vacuum to the orifice 209 and a nozzle vacuum system for applying a vacuum to the nozzle 111. In practice it is likely (as illustrated in FIGS. 9 and 10) that the same vacuum system will encompass both the measurement vacuum system and the nozzle vacuum system.

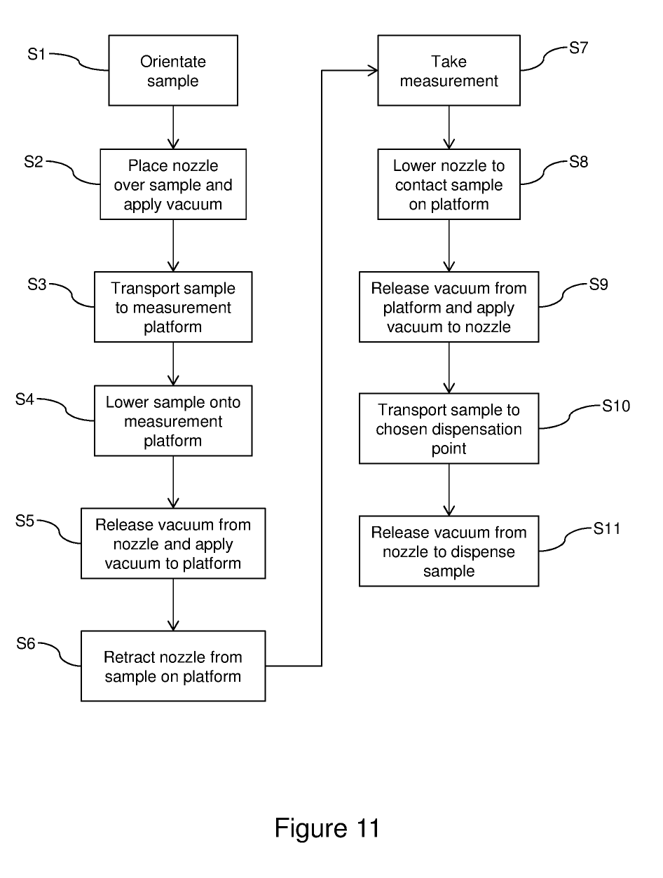

FIG. 11 is a flow chart showing the steps of operation involved in obtaining a measurement of a sample such as a gemstone:
S1. The sample is orientated using the orientation unit 102 or other suitable mechanism.
S2. The vacuum nozzle is placed over the sample and a vacuum applied so that the sample is retained in in the nozzle.
S3. The sample is transported by the wand to the measurement platform of the spectrometer.
S4. The sample is lowered onto the measurement platform at the measurement location.
S5. The vacuum is released from the nozzle of the wand and applied to the platform. It will be appreciated that these steps can be performed in either order or substantially simultaneously.
S6. The nozzle is retracted from the measurement platform, with the sample held in place at the measurement location by air pressure.
S7. A spectroscopic measurement is taken S8. The nozzle is lowered towards the measurement platform to contact the sample.
S9. The vacuum is released from the platform and applied to the nozzle.
S10. The sample is transported to a dispensation point chosen as a result of the spectroscopic measurement obtained.
S11. The vacuum is released from the nozzle to dispense the sample. Optionally a positive pressure is applied to ensure the stone is ejected from the nozzle.

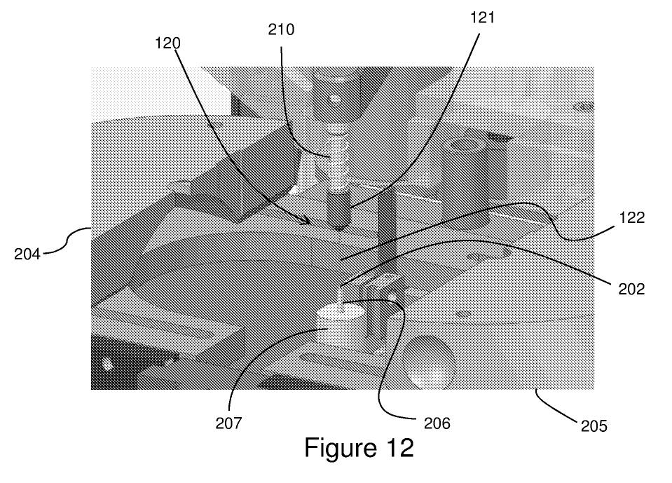

As discussed above, it is important that placement of the stone at the measurement location 802 is as accurate as possible. It is therefore desirable that the relative positions of the nozzle and measurement platform are well calibrated. One way of achieving this is to bring the nozzle 111 into the correct position relative to the measurement platform 202 for placing a stone at the measurement location, and recording the position of the pivotable arm 112 and wand 110. To assist with this, as shown in FIG. 12, a tool 120 may be placed over the nozzle 111. The tool 120 includes a generally cylindrical cap 121, optionally having a conical end, which can be fitted over the nozzle. A spigot 122 extends from the centre of the end of the cap 121. The spigot 122 has a diameter the same as (or very slightly smaller than) the diameter of the orifice 209 in the measurement platform 202.

In order to calibrate the position of the nozzle 111 relative to the measurement platform 202, the cap 121 is placed over the nozzle 111 and retained in place by vacuum in the same way as a stone would be. The wand 110 is moved towards the measurement platform 202. Correct alignment has been achieved when the spigot enters the orifice 209. If the centring of the nozzle 111 relative to the measurement platform 202 is incorrect, then the spigot 122 will rest on the upper surface of the measurement platform 202. The relative position of the spigot 122 compared to the orifice 209 will indicate the adjustment required to align the spigot and orifice.

The system described herein makes it possible to achieve accurate and repeatable placement of a sample such as a gemstone in a measurement position in a chamber purged of water vapour by transferring a vacuum from a carrying nozzle to an optimized measurement stage incorporating an orifice to allow for a vacuum to be applied from underneath. This enables the use of a small measurement stage for more accurate readings whilst minimizing sticking of the sample to the nozzle due to static build up caused by elimination of water vapour. Furthermore, the approach enables the maintenance of a system that allows reference spectra to be obtained simply and quickly between measurements without manual intervention.

The use of a vacuum applied to a platform enables stones up to 20 points (0.2 carat) to be measured on a platform of 1.4 mm diameter. The small platform is highly desirable to minimise any impact on measurement performance.

It will be appreciated that variations from the embodiments described above may still fall within the scope of the invention. For example, the apparatus described above includes an orientation unit provided in conjunction with a spectrometer, but the vacuum system will be appropriate for any device requiring transfer of a sample to a precise measurement location. Other measurement devices apart from spectrometers can be envisaged, for example optical devices configured to obtain images of samples for later analysis. Measurements of optical properties may include, but are not restricted to, measurement of absorption, transmission, luminescence, colour, clarity. Furthermore, other measurements requiring very precise initial location of a stone may be carried out. The approach described above is particularly appropriate to a measurement location in a chamber purged of water vapour because of the particular problem of static in dry environments but may be used in any situation requiring precise location.

Similarly, although the embodiments have been described above with reference to the transfer of cut gemstones, it will be appreciated that the approach is beneficial for the transfer of any samples with appropriate geometry. A vacuum nozzle may be used to transfer a sample from an orientation unit as described above, or from another form of orientation unit, or simply from a known location. Furthermore, a vacuum wand with a nozzle at an end has been described, but any transport mechanism capable of retaining a sample in a vacuum nozzle and moving that vacuum nozzle to and away from a measurement location may be envisaged.

1. An apparatus for placing a sample at a predefined measurement location for measuring an optical property of that sample, comprising:
a measurement platform for supporting the sample at the measurement location, the measurement platform having an orifice therein beneath the measurement location;
a nozzle configured to retain the sample therein when a vacuum is applied to the nozzle;
a nozzle vacuum system for selectively applying a vacuum to the nozzle;
a transport mechanism for moving the nozzle with the sample retained therein to the measurement location;
a measurement vacuum system for selectively applying a vacuum to the orifice in the measurement platform so as to retain the sample at the measurement location; and
a control system configured to control the nozzle vacuum system, measurement vacuum system and transport mechanism such that, when the sample has been transported to the measurement location by the nozzle:
the measurement vacuum system applies a vacuum to the orifice and the nozzle vacuum system cuts off the vacuum from the nozzle; and
the transport mechanism retracts the nozzle away from the measurement platform leaving the sample retained in place by the measurement vacuum system.

2. The apparatus of claim 1, wherein the control system is further configured, when a measurement of the sample has been obtained:
to cause the transport mechanism to advance the nozzle to contact the sample at the measurement location;
to cause the nozzle vacuum system to apply the vacuum to the nozzle and the measurement vacuum system to cut off the vacuum to the orifice; and
to cause the transport mechanism to transport the nozzle with the sample retained therein away from the measurement location.

3. The apparatus of claim 1, wherein the nozzle vacuum system and measurement vacuum system together comprise a pump for supplying a vacuum, and a diverter valve for applying the vacuum to either the nozzle or the orifice.

4. The apparatus of claim 1, further comprising a measurement instrument including a measurement chamber within which is located the measurement platform, the measurement chamber being configured so that it can be purged of water vapour.

5. The apparatus of claim 4, wherein the measurement chamber is configured to be flooded by a dry gas to a pressure higher than atmospheric pressure, and comprises an entry hole through which the nozzle with the sample retained therein can pass to reach the measurement location.

6. The apparatus of claim 4, further comprising a movable stage to which the measurement instrument or transport mechanism is mounted to enable precise adjustment of the relative locations of the measurement platform and the transport mechanism.

7. The apparatus of claim 4, wherein the measurement instrument is a spectrometer, optionally an absorption spectrometer, and optionally an FTIR spectrometer.

8. The apparatus of claim 1, wherein the transport mechanism comprises a pivotable arm from which is suspended a vacuum wand, the nozzle being provided in a distal end of the vacuum wand.

9. The apparatus of claim 1, further comprising an orientation unit for orientating samples into a suitable orientation for insertion into the nozzle prior to transportation to the measurement location.

10. The apparatus of claim 1, wherein the sample is a gemstone, optionally a cut gemstone.

11. The apparatus of claim 1 wherein the control system is configured to cause the transport mechanism to transport the sample to one of a plurality of dispensation points following the measurement, the dispensation point chosen in dependence on the outcome of the measurement.

12. The apparatus of claim 1, further comprising a tool for assisting with calibration of relative alignment of the nozzle and measurement platform, the tool comprising a cap configured to be located over the nozzle and held in place by the nozzle vacuum system, and a spigot extending from a distal end thereof and configured for insertion into the orifice when the nozzle and orifice are aligned.

13. A measurement instrument for measuring an optical property of a sample at a measurement location, comprising:
a generally sealed measurement chamber configured so it can be purged of water vapour;
a measurement platform within the measurement chamber for supporting the sample at the measurement location, the measurement platform having an orifice therein beneath the measurement location;
a measurement vacuum system for selectively applying a vacuum to the orifice in the measurement platform so as to retain the sample at the measurement location following delivery to the measurement location by a vacuum nozzle; and
an optical system for transmitting light to the measurement location and detecting light emitted from or passing through the measurement location so as to obtain a measurement of the optical property of the sample.

14. The measurement instrument of claim 13, further comprising an entrance hole in the measurement chamber to provide access to the measurement platform for the sample retained within the vacuum nozzle.

15. A method of placing a sample at a measurement location for measuring an optical property of the sample, comprising:
contacting the sample with a nozzle;
applying a vacuum to the nozzle so that the sample is retained therein by air pressure;
transporting the nozzle with the sample retained therein to the measurement location, the measurement location being on a measurement platform having an orifice therein;
disabling the vacuum at the nozzle to release the sample from the nozzle;
applying a vacuum to the orifice in the measurement platform so as to retain the sample on the measurement platform; and
retracting the nozzle away from the measurement platform.

16. The method of claim 15, wherein the steps of disabling the vacuum at the nozzle and applying the vacuum to the orifice are carried out substantially simultaneously by diverting a vacuum supply from the nozzle to the orifice.

17. The method of claim 15, further comprising taking an optical measurement of the sample at the measurement location.

18. The method of claim 17, further comprising, following the measurement:
advancing the nozzle to contact the sample on the measurement platform;
disabling the vacuum to the orifice to release the sample from the measurement platform;
applying a vacuum to the nozzle so as to retain the sample therein;
transporting the sample to a dispensation point; and
disabling the vacuum to the nozzle to dispense the sample.

19. The method of claim 18, further comprising applying positive gas pressure to the nozzle when dispensing the sample.

20. The method of claim 14, wherein the sample is a cut gemstone.

21. A method of calibrating alignment of a nozzle for transporting a sample to a measurement location with said measurement location, comprising:
placing an alignment tool having a cap and a spigot extending from a distal end thereof over said nozzle;
applying a vacuum to the nozzle so that the cap is retained thereon by air pressure;
transporting the nozzle with the cap retained thereon towards the measurement location, the measurement location being on a measurement platform having an orifice therein;
determining that the nozzle and measurement platform are correctly aligned if the spigot enters the orifice.

22. The method of claim 21, further comprising adjusting the position of the nozzle until the spigot is able to enter the orifice.
